(19) United States
(12) Patent Application Publication
(10) Pub. No.: US 2025/0292693 A1
(43) Pub. Date: Sep. 18, 2025

(54) Taskable Aerial Network

(71) Applicant: ResilienX, Inc., Syracuse, NY (US)

(72) Inventors: Andrew Carter, Liverpool, NY (US); Marc Viggiano, Manlius, NY (US); Matt Synborski, Erieville, NY (US); Ryan Pleskach, Liverpool, NY (US); Greg Dorchies, Jericho, VT (US)

(21) Appl. No.: 19/077,445

(22) Filed: Mar. 12, 2025

Related U.S. Application Data
(60) Provisional application No. 63/564,220, filed on Mar. 12, 2024.

(51) Int. Cl. G08G 5/56; B64U 70/80; G08G 5/26; G08G 5/30; G08G 5/57

(52) U.S. Cl. CPC G08G 5/56; B64U 70/80; G08G 5/26; G08G 5/30; G08G 5/57; B64U 2201/10

(57) ABSTRACT

A taskable aerial network includes a plurality of uncrewed vehicles, and a ground station executing a command and control subsystem in operable communication with the plurality of uncrewed vehicles and configured to receive a task input based on a timeline, a location, and/or a payload, receive a capacity input based on a location, a payload and an operational condition for an uncrewed vehicle, receive a traffic input based on a location of the uncrewed vehicles, receive a risk input and determine if the risk input passes a predetermined risk threshold, determine a flight plan based on at least one of the task input, the capacity input, the traffic input, and the risk input, and transmit the flight plan to the uncrewed vehicle to deploy the uncrewed vehicle to execute a task.

### CROSS REFERENCE TO RELATED APPLICATION(S)

The present application claims the benefit of and priority to U.S. Provisional 63/564,220 filed Mar. 12, 2024, title TASKABLE MUNICIPAL AERIAL NETWORK, the entire contents of which are hereby incorporated by reference herein.

### FIELD OF THE INVENTION

The present invention relates to advanced air mobility systems and provision of services in accordance with mission requirements. In particular, the present invention relates to a taskable aerial network system and method that addresses the operational and logistical challenges associated with integrating uncrewed aircraft systems (UAS) into urban, suburban, and regional environments.

### BACKGROUND

Advanced Air Mobility (AAM) is an emerging transportation paradigm to reshape the movement of people and goods in urban environments. The paradigm comprises innovative aircraft concepts, primarily electric vertical takeoff and landing (eVTOL) vehicles, coupled with sophisticated airspace management systems and ground-based infrastructure. AAM is developing to alleviate urban congestion, reduce travel times, enhance accessibility, and promote sustainability within the transportation sector.

Technological advancements in a number of areas are crucial to the realization of Advanced Air Mobility systems. First, electric vertical takeoff and landing (eVTOL) technology represents a cutting-edge approach to aviation, centered on electric propulsion, vertical flight capabilities, and innovative aircraft designs. Electric motors provide quieter and more environmentally sustainable operation than traditional engines. Their ability to take off and land vertically eliminates the need for runways, enabling them to operate within dense urban settings. eVTOL aircraft come in various configurations, including multi-rotor, tilt-rotor, and lift-plus-cruise designs, each offering unique advantages in terms of range, speed, and efficiency.

Second, electric vehicle propulsion systems rely on the conversion of electrical energy to mechanical energy for vehicle movement. At the core lies an electric motor (or motors), typically AC induction or permanent magnet synchronous motors for their high efficiency and power density. Power is supplied from a high-voltage battery pack, managed by a power electronics controller. This controller functions as an inverter, transforming DC power from the battery to AC power for the motor, while also precisely regulating motor speed and torque for optimal vehicle acceleration and energy efficiency. Advanced systems often incorporate regenerative braking, where the motor acts as a generator during deceleration, recapturing kinetic energy and feeding it back into the battery. Advancements in batteries and energy storage systems are critical in increasing operational range and payload capacity.

Third, autonomous vehicle control relies on a complex interplay of sensors, sophisticated algorithms, and actuation systems. A suite of sensors, including cameras, lidar, radar, and ultrasonic sensors, continuously gathers environmental data. This data is fused and processed by powerful onboard computers that use machine learning algorithms to perceive the environment, identify objects, and predict their trajectories. Based on this understanding, the vehicle's control system plans its path, taking into account traffic rules, obstacles, and its own capabilities. Commands for acceleration, braking, and steering are then sent to actuators, which physically execute the maneuvers, enabling the vehicle to navigate roads safely and independently.

Fourth, safe communication and traffic management require advanced communication, navigation, and surveillance (CNS) technologies are essential for integrating AAM operations into the existing airspace. Unmanned Aircraft System (UAS) Traffic Management (UTM) approaches will establish traffic flows, dynamic airspace allocation, and conflict resolution mechanisms within the low-altitude urban environment.

The increasing adoption of advanced air mobility AAM systems has the potential to transform the way urban and regional areas address critical challenges such as traffic congestion, environmental sustainability, and emergency responsiveness. AAM systems, powered by UAS and electric vertical take-off and landing (eVTOL) aircraft, promise innovative solutions to reduce operational costs, enhance accessibility, and promote safety and efficiency. However, the proliferation of these technologies is hindered by fragmented airspace management, under-utilization of assets, and the lack of scalable, automated platforms that can integrate multiple use cases into a unified system.

Municipalities present a myriad of use cases for AAM operations, which span the gamut from sUAS to large eVTOLs, including, but not limited to: (a) drone-as-a-first responder (DFR); (b) asset inspection; (c) security surveillance and enforcement; (d) municipal management (e.g., traffic, weather, water, power, emergency communications, crowd control, planning); (e) environmental control (e.g., air quality, trash management, etc.); (f) construction monitoring and related project management; (g) on-demand medical delivery (e.g., EpiPen, Narcan, defibrillator); (h) middle mile cargo delivery; and, (i) air ambulance services.

The widespread adoption of AAM will yield transformative benefits for society. First, AAM offers the ability to bypass congested roadways, thereby lowering traffic density and improving surface transportation efficiency thus reducing traffic congestion. With direct point-to-point flights at higher speeds than ground vehicles, AAM promises significant time savings for commuters and businesses yielding faster travel times. AAM has the potential to connect underserved communities and provide faster access to essential services such as healthcare and emergency response improving accessibility and access for many populations. Electric aircraft and optimized flight paths can reduce carbon emissions, noise pollution, and the overall environmental footprint associated with transportation contributing to sustainability targets and reduced urban carbon footprint. These and other benefits will result from the development, integration and deployment of AAM operations.

Current UAS operations often face barriers such as high costs of ownership (which creates a barrier to entry), limited interoperability between systems, and the need for specialized expertise in aviation operations to fully comply with the myriads of regulations found in aviation. Municipalities, public agencies, and private entities find it challenging to justify investments in aerial assets due to their infrequent and siloed use. For instance, a city might own drones for emergency response but lack the capacity to deploy them for other applications like infrastructure inspection or environmental monitoring. This results in significant underutilization of resources and redundant investments across sectors, or even different divisions of the same department.

The future of AAM hinges on collaborative efforts between industry, regulators, and research institutions to address these challenges in a timely and responsible manner. There remains a need for integrated platforms for the safe automation of the AAM ecosystem to facilitate development and deployment for the public good.

### SUMMARY OF THE INVENTION

The present invention addresses the above-discussed challenges by introducing a centralized platform that transforms UAS and eVTOL operations into a cohesive, taskable network. The invention enables municipalities and organizations to share resources, optimizing asset utilization while minimizing capital expenditures. By consolidating diverse use cases-such as drone-as-a-first-responder, asset inspection, environmental monitoring, and last-mile delivery—into a single system, the inventive system eliminates operational silos and facilitates efficient deployment of aerial resources.

One of the main advantages of the inventive system is its ability to automate complex processes such as risk assessment, flight planning, and resource prioritization. Unlike traditional systems, the present invention employs advanced algorithms to dynamically allocate resources based on task urgency, location, and availability, ensuring the highest-priority missions are completed first. Real-time risk management capabilities further enhance safety by continuously monitoring operational parameters such as weather, airspace traffic, and ground population density.

The inventive system has a modular architecture that integrates with existing aviation infrastructure and provides an application layer for third-party developers to create custom tools and applications. This extensibility supports a wide range of use cases while future-proofing the system for evolving demands. By abstracting the complexities of aviation operations, the inventive system empowers end-users-regardless of their technical expertise-to request and execute aerial missions effortlessly, and most importantly, repeatedly.

The present invention represents a paradigm shift in the adoption and deployment of AAM systems, offering a scalable, automated, and user-friendly platform that transforms uncrewed aerial operations into a versatile tool for public good. By addressing the challenges of asset underutilization, operational complexity, and scalability, the invention paves the way for widespread adoption of AAM systems in urban and regional environments.

In one exemplary embodiment, the present invention provides a taskable aerial network system including a plurality of uncrewed vehicles and a ground station executing a command and control subsystem in operable communication with the plurality of uncrewed vehicles. The command and control subsystem has a processor coupled to a memory, where the processor is configured to receive via a user interface module a task input including at least one of a timeline, a location, and a payload, receive via a resource capacity management module a capacity input including at least one of a location, a payload and an operational condition for each of the plurality of uncrewed vehicles, receive via a traffic management module a traffic input including a location and a flight plan for each of the plurality of uncrewed vehicles in a predetermined area, receive via a risk management module a risk input and determine if the risk input passes a predetermined risk threshold, determine a flight plan based on at least one of the task input, the capacity input, the traffic input, and the risk input, and transmit the flight plan to at least one of the plurality of uncrewed vehicles to deploy the uncrewed vehicle to execute a task.

In some embodiments, the processor is further configured via a secure data management module to segregate data collected by at least one of the plurality of uncrewed vehicles and to transmit the data only to an end user of the system.

In certain embodiments, the processor is further configured via a scheduling module to assign a priority factor to each task input, wherein the priority factor includes at least one of a deadline for task completion and a task type, and wherein the flight plan is determined based on the priority factor.

In some embodiments, the processor is further configured to transmit data to a user via the user interface module, the data including at least one of the flight plan, a vehicle location, a task progress, a vehicle telemetry feed, a video feed, an audio feed, and a multispectral sensor measurement.

In some cases, the traffic input includes a location of other vehicles and objects in a relevant airspace.

In certain embodiments, the risk input includes at least one of air risk issues, ground risk issues, and health, integrity and performance data associated with each of the plurality of uncrewed vehicles. In some of these embodiments, the air risk issues include at least one of suitable communications, global navigation satellite system performance, weather, surveillance availability, traffic density, and airspace. In additional embodiments, the ground risk issues include at least one of population density, restricted areas, battery reserves, a vehicle size and a vehicle weight.

In some embodiments, the processor is further configured to continuously receive at least one of the task input, the capacity input, the traffic input, and the risk input, automatically assess if the flight plan needs to be reconfigured based on the received input, automatically determine a new flight plan based on the received input, and transmit the new flight plan to the uncrewed vehicle.

In certain embodiments, the uncrewed vehicles are selected from a small uncrewed aircraft system, an electric vertical take-off and landing aircraft system, an urban air mobility vehicle, a drone, and an air ambulance vehicle.

In some embodiments, the system further includes a beyond visual line of sight drone control subsystem. In additional embodiments, the system also includes a Mode C Veil control subsystem.

A computer program product is also provided, including a non-transitory processor-readable storage medium having stored therein program code of one or more software programs. The program code, when executed by at least one processing device including a processor coupled to a memory, causes the at least one processing device to receive via a user interface module a task input including at least one of a timeline, a location, and a payload; receive via a resource capacity management module a capacity input including at least one of a location, a payload and an operational condition for each of a plurality of uncrewed vehicles; receive via a traffic management module a traffic input including a location and a flight plan for each of the plurality of uncrewed vehicles in a predetermined area; receive via a risk management module a risk input and determine if the risk input passes a predetermined risk threshold; automatically determine a flight plan based on at least one of the task input, the capacity input, the traffic input, and the risk input; and transmit the flight plan to at least one of the plurality of uncrewed vehicles to deploy the uncrewed vehicle to execute a task.

A method for automating and optimizing aerial operations using a taskable aerial network is further provided. The method includes the steps of receiving a task input including at least one of a timeline, a location, and a payload; receiving a capacity input including at least one of a location, a payload and an operational condition for each of a plurality of uncrewed vehicles; receiving a traffic input including a location of each of the plurality of uncrewed vehicles; receiving a risk input and determining if the risk input passes a predetermined risk threshold; determining a flight plan based on at least one of the task input, the capacity input, the traffic input, and the risk input; and transmitting the flight plan to at least one of the plurality of uncrewed vehicles to deploy the uncrewed vehicle to execute a task; wherein the steps are performed by at least one processing device including a processor operatively coupled to a memory.

In some embodiments, the method also includes the steps of receiving, by the processor, data collected by one of the plurality of uncrewed vehicles in response to the task input; segregating, by the processor, the data from data collected by other uncrewed vehicles; and transmitting, by the processor, the data to a user that transmitted the task input.

In certain embodiments, the method further includes receiving, by the processor, at least one of a task timeline, a resource availability and a user-defined parameter; determining, by the processor, a task prioritization input based on the at least one of the task timeline, the resource availability and the user-defined parameter; and determining the flight plan based on the task prioritization input. In some of these embodiments, the method also includes the step of allocating an uncrewed vehicle based on the task unput, the capacity input and the task prioritization input.

In some embodiments, the method also includes continuously receiving, by the processor, at least one of the task input, the capacity input, the traffic input, and the risk input; automatically assessing, by the processor, if the flight plan needs to be reconfigured based on the received input; automatically determining, by the processor, a new flight plan based on the received input; and transmitting, by the processor, the new flight plan to the uncrewed vehicle.

In certain embodiments, the method includes the step of transmitting, by the processor, data to a user, the data including at least one of the flight plan, an uncrewed vehicle location, a task progress, a video feed, an audio feed, and a multispectral sensor measurement, and a vehicle telemetry feed.

### BRIEF DESCRIPTION OF DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 shows a diagram for an exemplary embodiment of a taskable municipal aerial network in communication with an available aircraft network and municipal services in accordance with one or more illustrative embodiments of the present invention.

FIG. 2 shows a diagram for an exemplary embodiment of a taskable municipal aerial network showing a plurality of mission capabilities in accordance with one or more illustrative embodiments of the present invention.

FIG. 3 shows a diagram for an exemplary taskable municipal aerial network mission scenario in accordance with one or more illustrative embodiments of the present invention.

FIG. 4 shows a use case sequence diagram for an exemplary taskable municipal aerial network mission scenario in accordance with one or more illustrative embodiments of the present invention.

FIG. 5 shows a workflow diagram for an exemplary taskable municipal aerial network mission scenario in accordance with one or more illustrative embodiments of the present invention.

### DETAILED DESCRIPTION

The present disclosure describes through exemplary embodiments a taskable aerial network—a vehicle-agnostic platform for automating the sharing of resources and infrastructure to perform AAM operations.

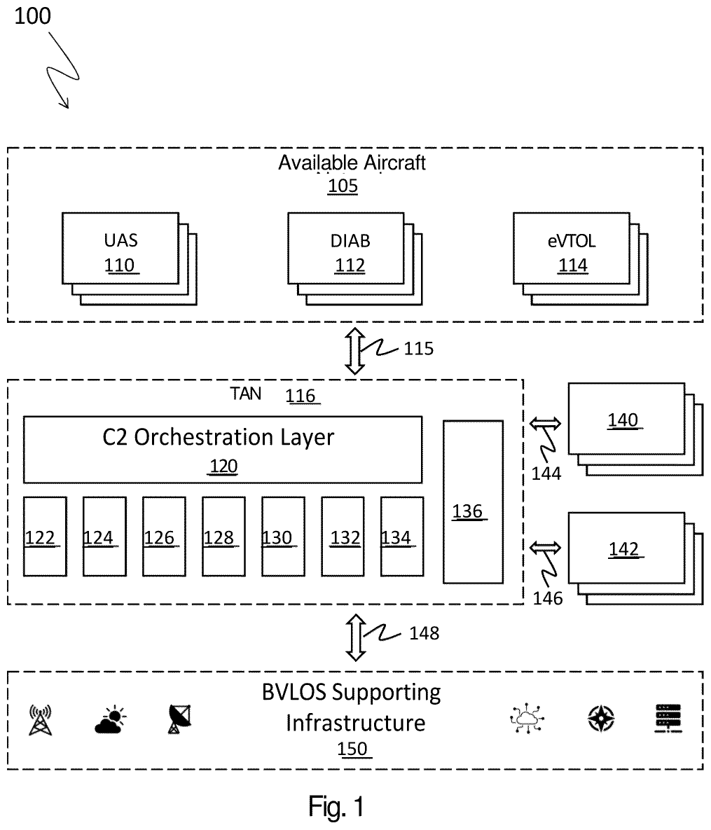

FIG. 1 displays major elements that are essential to the taskable aerial network (TAN) layer 116 of an exemplary embodiment on a functional AAM architecture 100. Vehicle agnostic orchestration is a key element of TAN middle layer 116. A basic analogy is to think of TAN as a 21st century 9-1-1 dispatcher, except not exclusively used for emergencies. The end user rarely cares about the drone; instead, they need to complete a task such as inspect a roof, monitor traffic, conduct agricultural spraying, surveil an area, search for a heat signature, or deliver a package. TAN lets the end user focus on the task, rather than the nuances of the aviation operation, by abstracting the aviation element. TAN integrates with the various craft ground control stations (GCS) or directly with the onboard flight control systems. It translates user intent (i.e., what is the task that needs to be performed) into flight plans, in-flight control messages, and traceable mission historical records. TAN operates as a set of cloud-based services running on cloud computing hardware in a third-party data center. Physical systems such as radar, weather sensors, communications systems, etc. provide data to the TAN cloud-based services. The TAN C2 Orchestration Layer (120) communicates with the UAS directly over a variety of network connections such as Long Term Evolution (“LTE”), satellite communications, and/or direct radio connection, and/or directly to a ground control station which then relays commands to the UAS over the same network connections. Third-party applications may live on a variety of third-party hardware components such as computers, cell phones, or tablets and task TAN via API calls.

The TAN layer 116 includes a uniform command and control (C2) orchestration layer 120 that interfaces with aerial assets, automating mission planning, execution, and monitoring while integrating with airspace management systems. The C2 layer 120 tracks and manages the status, readiness, and availability of all aerial assets within the network 100, converts user requests into executable flight plans and tasks, and collaborates with other subsystems to resolve potential conflicts during planning and execution. The C2 orchestration layer 120 performs autonomous (AI-based) execution based on system-determined task priority and risk assessment. For example, a flight plan may be automatically created for a task request to minimize flight time while taking into account airspace constraints, ground population density, airspace density, terrain and buildings, global navigation satellite system (GNSS) performance, communication performance, airspace surveillance availability, etc. The airspace constraints may be determined based on NOTAMS, which are written notices/communications issued to aircraft operators containing information essential to the flight operations such as the abnormal status of a component of the National Airspace System or temporary flight restrictions (TFRs) issued by the Federal Aviation Administration (FAA) to limit or prohibit aircraft from operating in a specific area for a set period of time, as well as other sources of information. This flight plan is strategically deconflicted from other UAS operations using a standardized deconfliction algorithm and interaction with a discovery and synchronization module described in more detail below. Missions are scheduled according to indicated priority and any additional constraints a mission request may have. For example, an imagery collection mission may request the images be taken on a sunny day, which initiate scheduling the mission during a forecast period of sun.

The C2 layer 120 performs its control functions using a suite of service subsystems responsible for critical tasks shown in FIG. 1. All internal TAN services and subsystem communicate via a secure data exchange through APIs or standardized data streaming protocols. In one exemplary embodiment, the TAN system 116 includes an in-time aviation safety management system (IASMS) 130 described in U.S. application Ser. No. 18/201,543, the disclosure of which is incorporated herein by reference in its entirety. IASMS 130 serves as the backbone of TAN, enabling real-time monitoring, risk assessment, and mitigation of adverse conditions to ensure the safety and reliability of all operations. IASMS 130 continuously monitors operational parameters, such as air and ground risks, operational hazards, potential conflicts, weather conditions, GNSS performance, and system health. This information is then utilized by TAN system for dynamic flight adjustments and resource allocations, air traffic deconfliction, and preemptive maintenance-all aiming to enhance the safety and resilience of AAM networks. IASMS 130 performs at least the following functions: (i) automated risk assessments during pre-flight planning and live operations, (ii) continuous monitoring for adverse or off-nominal conditions, with mitigation strategies applied in real-time, and (iii) integration with other TAN components to support decision-making and operational adjustments.

A traffic management module 122, which may include Unmanned Traffic Management (UTM), manages low-altitude airspace operations, primarily for drones and other unmanned aircraft systems (UAS) and plays a crucial role in enabling safe and efficient drone operations in specific areas. The traffic management module 122 ensures safe and efficient operation of UAS within the airspace by integrating UTM protocols, which are a means for UAS Service Suppliers (“USSs”) to interoperate with each other, via the ASTM F3548-21 USS Interoperability Standard Specification, available at https://github.com/interuss (last accessed on Mar. 10, 2025) the content of which is incorporated herein by reference in its entirety. TAN functions as an arbitrator and USS participant, ensuring that the health and performance of the USS it monitors and assesses is within predetermined parameters. When TAN determines that the USS is not behaving in accordance with the predetermined parameters, it will perform mitigations in accordance with the InterUSS protocol to communicate this to the UTM ecosystem, including the transfer of its flight operations to another USS via the discovery and synchronization module-USS functions of the system. As a USS participant, TAN performs operational risk assessment and operational conformance monitoring as an augmentation to the basic airspace coordination functions within the ASTM F3548-21. The traffic management module 122 performs at least the following functions: (i) strategic deconfliction of multiple operations within shared airspace, (ii) real-time monitoring of airspace compliance and dynamic re-routing to avoid non-cooperative traffic, and (iii) communication with IASMS to dynamically adjust flight plans based on evolving risks or conditions. The UTM system sends a proposed flight plan to the IASMS to see if there are any airspace risks associated with the health, integrity, or performance of the systems that the IASMS is monitoring. Once given a flight plan, the IASMS will monitor these risks, until the flight has completed, and alert the UTM system of any risks change leading up to or during an operation.

An automation orchestration module 128 operates to ensure end-to-end automation of mission workflows, reducing manual intervention and improving efficiency. The automation orchestration module 128 performs at least the following functions: (i) coordination of data flows between system components, ensuring smooth operation, (ii) automation of resource allocation based on task parameters, asset availability, and priority levels, and (iii) monitoring of overall system performance and optimizing workflows to minimize delays and errors. The automation orchestration module operates via AI-driven orchestration. The module is designed to maximize safety first and efficiency of the network second. The module is made aware of resource constraints such as number of available systems, approved operational areas, pilots, battery levels, charging times, existing planning missions, etc. and works to coordinate requests across these various constraints on the system. The majority of this orchestration is done pre-flight. During flight, the C2 orchestration layer handles tactical aspects associated with flying the drone systems.

The TAN layer 116 may further include the following modules: resource capacity management 124, air and ground risk management 126, priority-based scheduling 132, and data management and distribution 134.

TAN may utilize resources in the available aircraft network 105 including, but not limited to:

Unmanned Aircraft Systems (UAS) 110 is a broad category of remotely controlled or autonomous aerial vehicles that are not intended to carry onboard pilots. They may range in size from small consumer drones to larger military platforms. A typical UAS includes the aircraft itself, equipped with cameras, sensors, and potentially other payloads. UAS may also involve ground control stations, where a remote pilot may operate the system via a datalink, as well as software elements that govern flight planning and potential autonomous functions. These systems are utilized for diverse applications such as aerial photography, infrastructure inspection, package delivery, and military surveillance.

Drone-in-a-Box (DIAB) 112 systems may provide autonomous housing, charging, and deployment capabilities for aerial vehicles, primarily drones. The DIAB enclosure offers protection from the elements and potential theft or tampering. It typically includes a landing platform, a battery charging system, and often cameras for situational awareness. DIAB systems may integrate with remote control or fleet management software, enabling autonomous drone launch for tasks like surveillance, inspection, or delivery. These systems are designed for persistent operations where manual drone management is impractical or labor-intensive.

Electric Vertical Take-Off and Landing (eVTOL) 114 aircraft typically rely on electric motors for propulsion, enabling quieter, more efficient, and potentially lower-maintenance operation compared to traditional helicopters. Their ability to take off and land vertically eliminates the need for runways, giving them the flexibility to operate within dense urban settings. eVTOL aircraft may come in various configurations, such as multi-rotor, tilt-rotor, or lift-plus-cruise designs, each offering its own blend of advantages in terms of range, speed, and efficiency.

The C2 Orchestration layer 120 interacts with the available aircraft network 105 through communication and software interfaces 115 through either direct access to an onboard agent running on a companion computer on the aircraft, which communicates directly with the autopilot, or via API interactions with the ground control station(s). The autopilot interface may vary from craft to craft and may necessitate a custom integration for each new vehicle/autopilot combination. The C2 Orchestration layer interfaces with rest of the TAN elements via API calls to make sure that all flight plans and commands result in safe operations and mitigates conflicts at the planning level before the flight is initiated. The C2 Orchestration layer tells the drone where to go and what to do. This may include controlling the payload as well as sending commands to the autopilot (directly or via the ground control station). The C2 Orchestration layer listens to the telemetry feed from the drone and may adjust directions based on how the drone or payload is responding. Drones with onboard AI may inform the C2 Orchestration layer when they are executing additional maneuvers such as avoiding an incoming aircraft or avoiding a telephone line.

Other services may interact with the TAN platform 116 through an application layer module 136. The application layer module 136 is a flexible layer designed for extensibility, enabling users and developers to create mission-specific applications or ways to add insights and analysis to data collected. The application layer module 136 may include application programming interfaces (APIs) and software development kits (SKDs) providing applications interfaces. Through these interfaces 144 and others communication modalities 146, the TAN platform may communicate with application-specific 3rd party data processing systems 140 and application-specific 3rd party display systems 142, supporting custom tools such as infrastructure inspection analytics, real-time video processing, and emergency response dashboards. The application layer module 136 enables a marketplace for mission-specific applications, enabling stakeholders to tailor TAN capabilities to their need.

These middle-layer TAN C2 systems and services subsystems provide capable management and deployment capabilities utilizing 148 resources available in the Beyond Visual Line of Sight (BVLOS) infrastructure 150 referring to the command and operation of unmanned aircraft (e.g., drones) where the remote pilot cannot maintain direct, unaided visual contact with the aircraft. BVLOS operations are crucial for expanding the capabilities of drones in applications like long-range delivery, infrastructure inspection, and surveillance. To ensure safety, BVLOS flights necessitate robust detect-and-avoid systems, reliable communication links for command and control, and often require special regulatory approval or waivers supported, in part, by the TAN controller. Additionally, advanced airspace management systems can be coordinated using TAN services to integrate BVLOS operations safely with other air traffic.

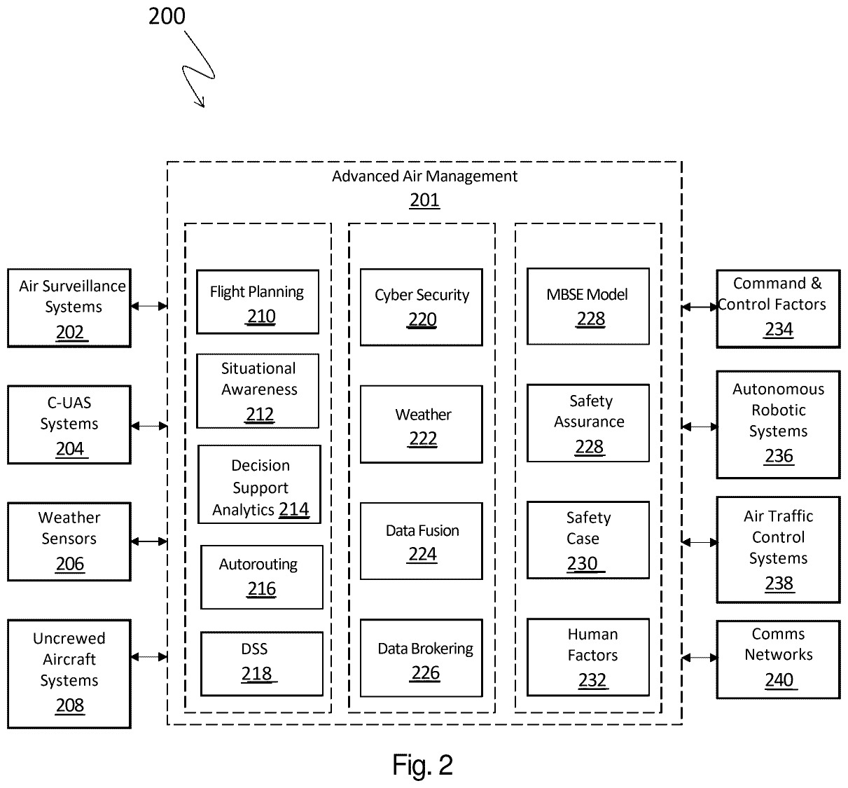

FIG. 2 illustrates the key functions 200 supported by the TAN architecture to provide AAM mission services for a large variety of use cases including, but not limited to, drone-as-a-first responder (DFR), asset inspection, security, municipal management (traffic, weather, water, power, emergency communications, crowd control, planning), environmental control (air quality, trash management), construction monitoring and related project management, on-demand medical delivery (EpiPen, Narcan, defibrillator), middle mile cargo delivery, and air ambulance missions. Such missions require advanced air management 201 to utilize and deploy capabilities including flight planning 210, situational awareness 212, decision support analytics 214, autorouting 216, discovery and synchronization module 218, cybersecurity 220, weather monitoring and prediction 222, data fusion 224, data brokering 226, model-based systems engineering models 228, safety assurance 229, safety case management 230, and human factors accommodations 232. TAN provides capabilities, communications and controls to achieve missions utilizing and managing a variety of resources including air surveillance systems 202, counter-unmanned aircraft systems (C-UAS) 204, weather sensors 206, uncrewed aircraft systems 208, command and control factor demands 234, autonomous robotic systems 236, air traffic control systems 238 and communications networks 240. TAN interacts with these resources through a secure data exchange, which interfaces with each resource directly using whatever existing protocol or API the resource has available for data transfer and interaction. This data, such as airspace surveillance, is used across the TAN services to maximize safety and efficiency of the network. Airspace surveillance data, for example, is used over time to determine airspace density maps and in real-time for strategic avoidance of other aircraft in the airspace.

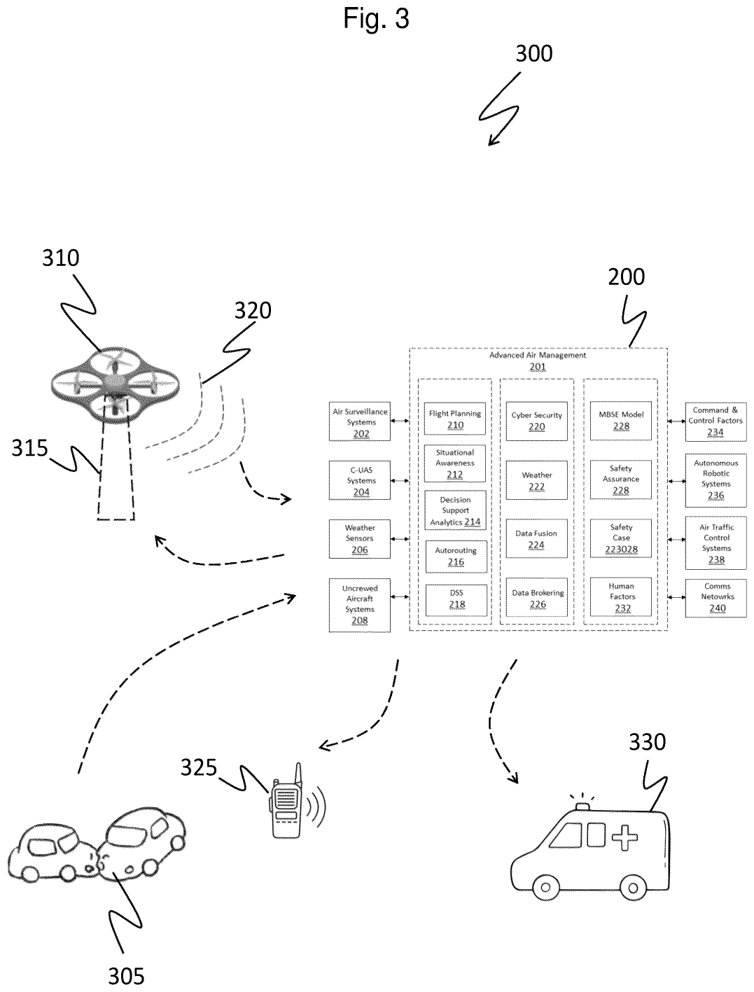

Such missions can be described by use cases, a means for providing a structured narrative that captures a specific interaction between a user and a system. It describes a particular way in which a user will employ the system to achieve a goal or complete a task. FIG. 3 describes an exemplary AAM mission scenario 300 supported by the TAN architecture. When a task request is received by the TAN system (through the application layer), the TAN Automation Orchestration module identifies the best resource to perform the task, as close to the task parameters as possible, and generates an initial flight plan for the task (utilizing the C2 Orchestration module), which is optimized for battery efficiency. Task parameters may include, but are not limited to, a timeline, a location, a payload specification, environmental conditions (such as weather), data collection methodology (various angles or flight paths), etc. This initial flight plan is checked against constraints (airspace, risk-based, tactical deconfliction) to determine if any deviations need to be made for safety reasons. As an example, a highway accident 305 may trigger a request to get a video feed 315 of the scene as soon as possible to inform emergency response. A nearby SUAS 310 with a camera payload would be tasked with a top priority to get to the scene of the accident and communicate the data 320 with the TAN infrastructure-supported air management system 200. Once on scene, it may be clear to the emergency response team in communication with TAN 325 from the SUAS video feed 315, that an ambulance 330 is needed. This would trigger a second task to TAN to send an autonomous air ambulance to the scene. The first air ambulance which was ready (i.e., was loaded with a paramedic, who is not a pilot) would be tasked to land near the accident site. A third-party application may review the video from the SUAS 310 and identify a suitable landing location for the air ambulance and feed back into TAN 200. In this scenario, there were no UAS or eVTOL pilots in the emergency response organization. No personnel were required to be trained about aviation, airspace, or robotics.

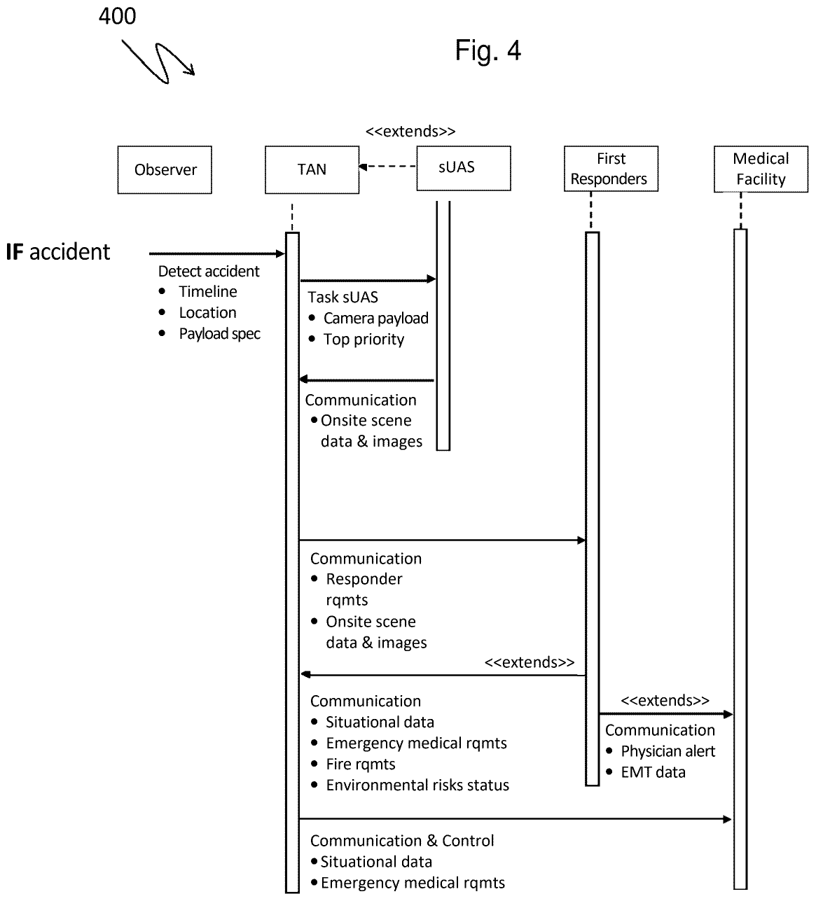

Various use cases may be developed for TAN implemented AAM and the details of mission-critical deployment of resources and assets may be refined. FIG. 4 illustrates a UML (unified modeling language) use case sequence diagram 400 for the accident scenario described in FIG. 3. Use case analysis like that depicted by FIG. 3 and FIG. 4 ensure that the TAN architecture can deploy mission assets with a high degree of success.

Another exemplary use case is precision agriculture, where the TAN system can significantly enhance the process by providing real-time data to optimize crop health, irrigation, and yield. For instance, a farmer can request a drone to perform a field survey, specifying parameters like crop type, growth stage, and any observed issues. TAN autonomously deploys a drone equipped with multispectral sensors to gather detailed imagery. This imagery is passed to a 3^{rd} party data analysis application to identify areas with nutrient deficiencies, pest infestations, or irrigation issues. This data is then processed and delivered directly to the farmer's device, allowing targeted treatments that reduce waste and improve crop yield. Other examples of use cases include rapid response in emergency situations, firefighting and law enforcement uses, delivery services, transportation management, environmental control, on demand medical delivery, construction monitoring, municipal management, operations and logistics, providing critical services to remote areas, providing improved accessibility for people with disabilities, infrastructure inspection, disaster risk reduction, etc. These use cases are all supported with shared assets, without the need for pilots or regulatory certification/waivers for any of the tasking organizations.

Such use cases are based on scenario planning-mapping event sequences-for demands by various services. When TAN receives a request for a task, it immediately begins the planning process. This process is iterative between the C2 Orchestration module 120 and the Traffic Management module 122, facilitated by the Automation Orchestration module. The Automation Orchestration module will pick the asset that it thinks is best suited for the task based on the resource constraints within the network and the constraints given by the task itself, as described above. The Automation Orchestration will identify the assets and payload best suited to execute the mission and then tell the C2 Orchestration to calculate a likely flight plan for the task requested using the selected asset. C2 Orchestration will send this suggested plan to the Traffic Management module to verify the flight planning and provide clearance for execution. It may turn out, that during the flight planning/approval process, the chosen asset becomes unavailable, in which case the Automation Orchestration process would be notified, and a new asset would be chosen, starting the process over again.

The automated flight planning process is fed the details about a task including the chosen craft specifications, details about the various locations involved, and anything about the payload or mission requirements which may affect the flight plan such as image resolution, environmental requirements (sunny, nighttime, ambient temperature, etc.), angle of approach, etc. From this information, a flight plan is calculated. After approved, this flight plan is then passed to the Risk Management module 130 to identify any air or ground risk issues which may require flight plan adjustment such as communication, navigation, or surveillance system performance degradations, higher than expected ground risk, supporting system failure, etc. Once a flight plan has passed a risk threshold, it goes through the strategic deconfliction process identified in the standard between unmanned surface vehicle (UAS) service suppliers (UAS Service Suppliers) (equivalently, ASTM USS-to-USS) standard. This process involves checking with all USSs supporting operations in the area that no two operations will be in the same place at the same time—or 4D strategic deconfliction.

When the operation transitions from planning to a live operation, the Traffic Management module 122 works in coordination with the C2 orchestration module 120 to monitor the flight for conformance to its flight plan or operational area. Conformance monitoring involves verifying that the aircraft stays within the 4D operational volume which it was assigned during the strategic deconfliction process. If the aircraft leaves that volume, all other nearby operations are alerted via a discovery and synchronization module. The two systems are also responsible for rapid re-planning or re-routing if a contingency situation occurs such as a system failure or intruding non-cooperative aircraft, while logging all activity related to the mission execution.

Automating the risk management of uncrewed operations facilitates the safe operation of TAN. Risk thresholds need to be set through the waiver, exemption, or regulatory process for various elements or air and ground risk. For example, a craft will have a performance envelope which determines the safe performance parameters. One of these parameters may be external wind. If the predicted wind on a flight path is higher than the wind parameter in the craft performance envelope, then the risk is deemed unacceptable. Note that this same wind profile may be deemed an acceptable risk to a craft with a different performance envelope. Once set, these risks need to be assessed and monitored for changes, in the previous example, and change to the weather could cause the risk profile to change. Factors that contribute to air risk may include suitable communications, global navigation satellite system (GNSS) performance, weather, surveillance availability, traffic density, airspace restrictions, etc. Factors that contribute to ground risk may include population density, battery reserves, location restrictions, craft size/weight, etc.

All flight plans will be automatically checked against various risk factors and either approved or rejected due to risk elements above a designated risk threshold. The Risk Management module 130 may interact with the Traffic Management module 122 to identify an alternate flight plan that avoids the triggering risk factor. During operations, risk elements will be monitored and if an event occurs which puts the risk over a threshold, a similar process will automatically occur, during the live operation. Note that this could result in an aborted operation if no suitable alternative exists.

The IASMS module 122 monitors the health, integrity, and performance of the overall networked system of systems. It assesses any adverse or off-nominal conditions and identifies available mitigation strategies. These strategies may be automatically implemented or may be presented to a user who is responsible for contingency management. Contingency management is integrated with traffic management and C2 orchestration so that mitigations can be automatically triggered and users managing contingency situations gain an understanding of what TAN is doing automatically and what the implications are.

Secure data management enables disparate users to task the TAN system and not worry that the data they are collecting will be seen by others. While the flight plan and craft telemetry information will be fed back through the TAN system to enable safe aviation, all payload and sensor data will be segregated and available to the end user that tasked the system. That is, data that one user paid for will not be sent to another user. Further, application specific data processing and data visualization tools may be integrated into TAN through the application layer. Sets of sensor operation rules may be set up for the flight plan in the C2 Orchestration to prevent unwanted sensor use or the capture of non-authorized prohibited/sensible data.

The resource capacity management module 124 functions to determine/measure the current and predicted future status of each resource utilized by TAN, including vehicle/aircraft, airspace including AAM corridors, drone ports or take-off/landing pads, charging infrastructure, vertiports, etc. The status and availability of these resources affects the capacity of utilization and needs to be matched against the demand for each resource, which is performed by the resource capacity management module 124. For example, a drone with 50% battery may not be an available resource for a task which will take 60% of a full battery to complete. In this case, a different drone asset will need to be selected or the task will need to be delayed until the battery is charged. Optimizing the demand capacity balancing across a range of resources is the role of the resource capacity management module.

The priority-based scheduling module 132 enables TAN to be shareable with entities that span federal, state, and commercial interests. Tasks are assigned with a deadline for completion. Tasks with immediate to short deadlines are prioritized accordingly, whereas tasks with longer deadlines are more flexible and cost-effective. Additionally, the tasks/missions may be prioritized based on a task type, e.g., emergency situation>public safety>public use>commercial use, etc. An important element of priority-based scheduling is the ability to preempt a lower priority task, even during a live operation. In some exemplary embodiments, preemption for a live flight may be reserved for emergency situations. For example, a drone is tasked to take some real-estate images and has just taken off when a fire call comes in. The drone, which is already in the air and calculated to be the first available asset to reach the fire and have the requisite payload, is rapidly swapped from the video task to head to the fire. New routes are calculated and approved, battery and flight time are checked, data is shut off from the real-estate firm and instead routed to the fire department, and a risk assessment is completed, all automatically, by the TAN system. A different drone will resume the real-estate mission, or it will be completed after the higher priority mission is completed since the real-estate mission is not as time sensitive.

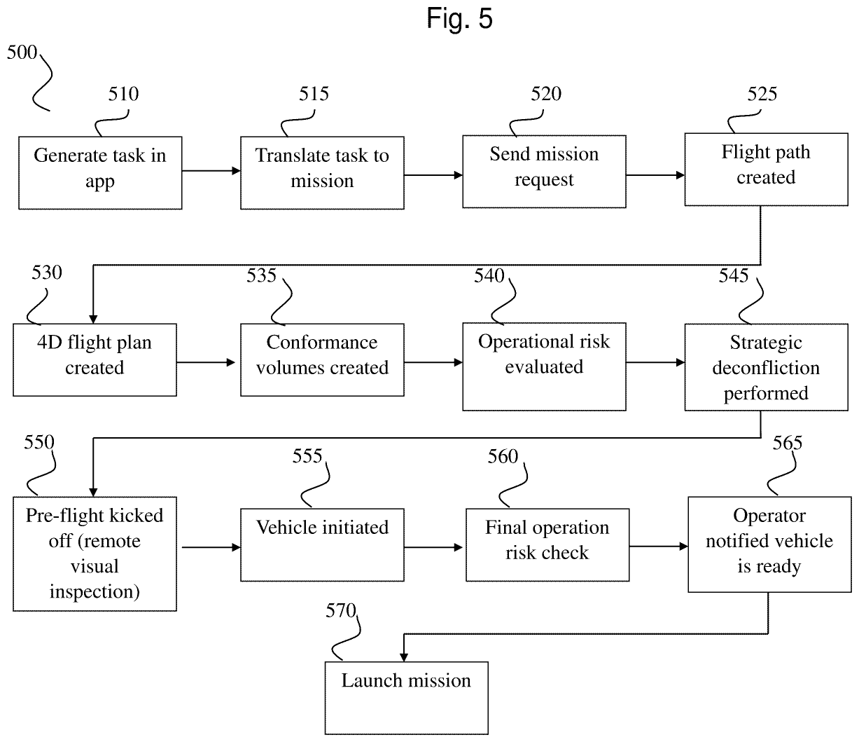

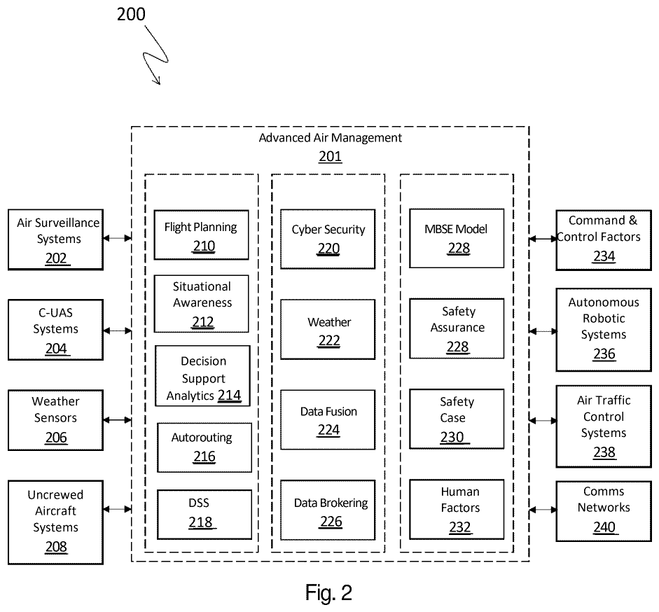

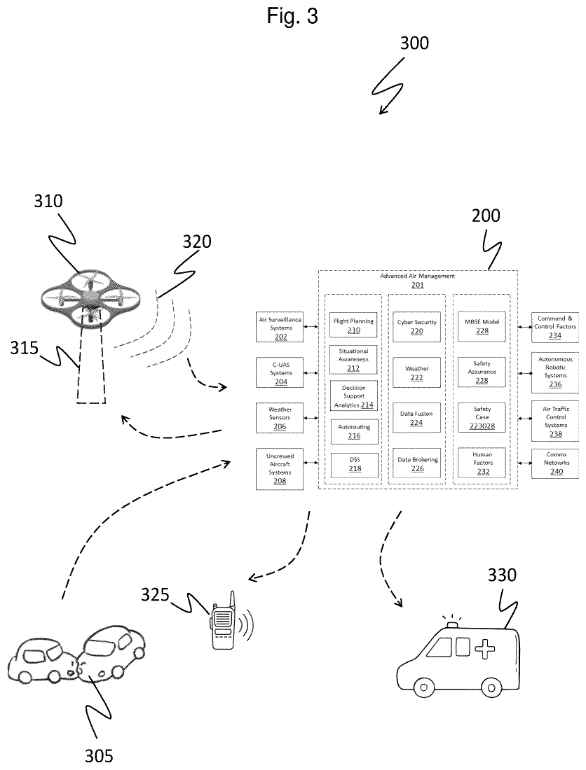

FIG. 5 is a flow chart illustrating an exemplary operational workflow 500 for the TAN system. First, a task is generated 510 by a user, for example through a user-friendly mobile or web third-party application with a user interface. The generated task is communicated to TAN through the application layer module. The TAN module evaluates resource availability and selects the optimal aerial asset based on the given task parameters, which include, but are not limited to, a timeline, a location, and a payload specification. The task is then automatically converted to a mission 515 and a mission request 520 is generated. Tasks may have very prescriptive details (fly this exact flight plan) or may be intent based (follow that car). Tasks are first translated to a mission request, which may involve using AI to fill in elements of the mission request which were not available in the task request such as altitude, payload sensor configuration, etc. This process is iterative between the C2 Orchestration module and the Traffic Management module. The Automation Orchestration module will pick the asset and payload that it thinks is best suited for the task and then tell the C2 Orchestration module to calculate a flight plan 525. C2 Orchestration module will send this suggested plan to the Traffic Management module to verify flight planning and provide clearance for execution. If the selected asset becomes unavailable, during the flight planning/approval process (e.g., fails a self-test or is preempted for a higher priority mission) the Automation Orchestration process would be notified, and the asset identification process will begin anew.

The automated flight planning process is fed the details about a task including the chosen craft specifications, details about the locations involved, and anything about the payload or mission requirements which may affect the flight plan. From this information, a 4D flight plan 530 is calculated and conformance volumes are created 535. Conformance volumes are necessary to strategically deconflict with other UAS flights using a UTM system that may be operating in the same area. Once approved, this flight plan is then passed to the Risk Management module to evaluate operation risk 540 and identify any air or ground risk issues which may require flight plan adjustment. Once a flight plan passes a risk test (i.e., risk is within tolerance), it goes through the strategic deconfliction process 545, such as, e.g., identified in the ASTM USS-to-USS standard (F3548-21) where the mission is strategically deconflicted with other missions and unsafe airspace, meaning no two operations are planned to occur in the same 4D airspace at the same time and all airspace is available for operations. Next, the pre-flight safety checks 550 are automatically run to ensure the operational condition of the vehicle and the vehicle is initiated 555. A final operation risk check 560 is performed by the Risk Management module and once approved, the user/operator is notified 565 by TAN that the vehicle is ready, and the mission is launched 570 via the C2 Orchestration module, which is in control of the vehicle via a direct integration with the onboard autopilot or with the ground control station.

The present TAN technology introduces transformative benefits for advanced air mobility systems by addressing critical challenges in asset utilization, operational complexity, and safety. TAN provides operational efficiency by minimizing manual intervention by automating task planning, execution, and monitoring through the C2 orchestration layer. A priority-based scheduling system ensures that high-urgency missions, such as emergency response, take precedence over routine operations. Real-time capacity management optimizes the use of aerial assets, infrastructure, and airspace corridors, reducing downtime and maximizing utilization.

The TAN system also provides enhanced safety by leveraging the IASMS module to dynamically assess air and ground risks, including adverse weather, GNSS disruptions, and airspace congestion. Automated mitigation strategies ensure safe operations during both planning and execution phases. Integration with UAS Traffic Management (UTM) protocols ensures airspace compliance and facilitates beyond visual line of sight (BVLOS) operations. TAN's IASMS module continuously monitors operational conditions and triggers automated contingency plans to mitigate off-nominal events.

Another advantage of the TAN system is scalability and flexibility. TAN supports phased deployment, allowing municipalities and organizations to scale operations as needed. APIs and SDKs provided in the application layer enable third-party developers to create mission-specific tools, fostering innovation and adaptability to emerging use cases. TAN accommodates diverse applications, including emergency response, infrastructure inspection, logistics, and precision agriculture.

A further advantage of the TAN system is its cost-effectiveness. Centralizing assets into a taskable network eliminates the need for redundant investments by individual stakeholders, significantly reducing capital expenditures. Real-time monitoring of asset health and performance minimizes downtime and extends the lifecycle of aerial assets.

The present TAN technology represents an advanced framework for automating and optimizing aerial operations. Its modular architecture ensures real-time monitoring, risk mitigation, and compliance with airspace regulations. TAN addresses key engineering challenges, such as dynamic resource allocation, automated task prioritization, and secure data management, making it suitable for diverse operational scenarios. TAN's design facilitates scalability and interoperability, supporting both phased deployment and integration with existing aviation infrastructure. Core components, including the C2 orchestration layer, the traffic management module, and the application layer, provide flexibility to adapt to evolving requirements and emerging technologies. Real-time risk assessments, task scheduling, and mission execution are handled autonomously, reducing operational complexity and enhancing reliability. The innovative TAN system is engineered to support a wide range of use cases, including emergency response, infrastructure monitoring, and logistics, through seamless coordination of aerial assets. Its ability to integrate and optimize resources ensures efficient use of airspace and compliance with operational safety standards. TAN's emphasis on modularity, automation, and safety ensures it meets the technical demands of advanced air mobility applications, providing a robust foundation for future aerial operations.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced items. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

1. A taskable aerial network system comprising:
a plurality of uncrewed vehicles; and
a ground station executing a command and control subsystem in operable communication with the plurality of uncrewed vehicles, the command and control subsystem comprising a processor coupled to a memory, the processor configured to:
receive via a user interface module a task input comprising at least one of a timeline, a location, and a payload;
receive via a resource capacity management module a capacity input comprising at least one of a location, a payload and an operational condition for each of the plurality of uncrewed vehicles;
receive via a traffic management module a traffic input comprising at least one of a location and a flight plan for each of the plurality of uncrewed vehicles in a predetermined area;
receive via a risk management module a risk input and determine if the risk input passes a predetermined risk threshold;
determine a flight plan based on at least one of the task input, the capacity input, the traffic input, and the risk input; and
transmit the flight plan to at least one of the plurality of uncrewed vehicles to deploy the uncrewed vehicle to execute a task.

2. The system of claim 1, wherein the processor is further configured via a secure data management module to segregate payload data collected by at least one of the plurality of uncrewed vehicles and to transmit the payload data only to an end user of the system.

3. The system of claim 1, wherein the processor is further configured via a scheduling module to assign a priority factor to each task input, wherein the priority factor comprises at least one of a deadline for task completion and a task type, and wherein the flight plan is determined based on the priority factor.

4. The system of claim 1, wherein the processor is further configured to transmit data to a user via the user interface module, the data comprising at least one of the flight plan, a vehicle location, a task progress, a vehicle telemetry feed, a video feed, an audio feed, and a multispectral sensor measurement.

5. The system of claim 1, wherein the traffic input comprises a location of other vehicles and objects in the predetermined area.

6. The system of claim 1, wherein the risk input comprises at least one of air risk issues, ground risk issues, and health, integrity and performance data associated with each of the plurality of uncrewed vehicles.

7. The system of claim 6, wherein the air risk issues comprise at least one of suitable communications, global navigation satellite system performance, weather, surveillance availability, traffic density, and airspace restrictions.

8. The system of claim 6, wherein the ground risk issues comprise at least one of population density, restricted areas, battery reserves, a vehicle size and a vehicle weight.

9. The system of claim 1, wherein the processor is further configured to:
continuously receive at least one of the task input, the capacity input, the traffic input, and the risk input;
automatically assess if the flight plan needs to be reconfigured based on the received input;
automatically determine a new flight plan based on the received input; and
transmit the new flight plan to the uncrewed vehicle.

10. The system of claim 1, wherein the plurality of uncrewed vehicles are selected from a small uncrewed aircraft system, an electric vertical take-off and landing aircraft system, an urban air mobility vehicle, a drone, and an air ambulance vehicle.

11. The system of claim 1, further comprising a beyond visual line of sight drone control subsystem.

12. A computer program product comprising a non-transitory processor-readable storage medium having stored therein program code of one or more software programs, wherein the program code, when executed by at least one processing device comprising a processor coupled to a memory, causes the at least one processing device to:
receive via a user interface module a task input comprising at least one of a timeline, a location, and a payload;
receiving a task prioritization input based on at least one of a task timeline, a resource availability and a user-defined parameter;
receive via a resource capacity management module a capacity input comprising at least one of a location, a payload and an operational condition for each of a plurality of uncrewed vehicles;
receive via a traffic management module a traffic input comprising at least one of a location and a flight plan for each of the plurality of uncrewed vehicles in a predetermined area;
receive via a risk management module a risk input and determine if the risk input passes a predetermined risk threshold;
automatically determine a flight plan based on at least one of the task input, the task prioritization input, the capacity input, the traffic input, and the risk input; and
transmit the flight plan to at least one of the plurality of uncrewed vehicles to deploy the uncrewed vehicle to execute a task.

13. A method for automating and optimizing aerial operations using a taskable aerial network comprising the steps of:
receiving a task input comprising at least one of a timeline, a location, and a payload;
receiving a capacity input comprising at least one of a location, a payload and an operational condition for each of a plurality of uncrewed vehicles;
receiving a traffic input comprising at least one of a location and a flight plan for each of the plurality of uncrewed vehicles in a predetermined area;
receiving a risk input and determining if the risk input passes a predetermined risk threshold;
determining a flight plan based on at least one of the task input, the capacity input, the traffic input, and the risk input; and
transmitting the flight plan to at least one of the plurality of uncrewed vehicles to deploy the uncrewed vehicle to execute a task;
wherein the steps are performed by at least one processing device comprising a processor operatively coupled to a memory.

14. The method of claim 13, further comprising:
receiving, by the processor, data collected by one of the plurality of uncrewed vehicles in response to the task input;
segregating, by the processor, the data from data collected by other uncrewed vehicles; and
transmitting, by the processor, the data to a user that transmitted the task input.

15. The method of claim 13, further comprising:
receiving, by the processor, at least one of a task timeline, a resource availability and a user-defined parameter;
determining, by the processor, a task prioritization input based on the at least one of the task timeline, the resource availability and the user-defined parameter; and
determining the flight plan based on the task prioritization input.

16. The method of claim 15, further comprising the step of allocating an uncrewed vehicle based on the task unput, the capacity input and the task prioritization input.

17. The method of claim 13, further comprising:
continuously receiving, by the processor, at least one of the task input, the capacity input, the traffic input, and the risk input;
automatically assessing, by the processor, if the flight plan needs to be reconfigured based on the received input;
automatically determining, by the processor, a new flight plan based on the received input; and
transmitting, by the processor, the new flight plan to the uncrewed vehicle.

18. The method of claim 14, further comprising the step of transmitting, by the processor, data to a user, the data comprising at least one of the flight plan, an uncrewed vehicle location, a task progress, a vehicle telemetry feed, a video feed, an audio feed, and a multispectral sensor measurement.
